(19) United States
(12) Patent Application Publication
(10) Pub. No.: US 2010/0195641 A1
(43) Pub. Date: Aug. 5, 2010

(54) Seamless multi-mode voice

(75) Inventor: Wei Kang Tsai, Irvine, CA (US)

Correspondence Address: Wei Kang Tsai, 8 Young Court, Irvine, CA, 92617, US

(73) Assignee: Grasstell Networks LLC

(21) Appl. No.: 12/322,558

(22) Filed: Feb. 4, 2009

(51) Int. Cl. H04L 12/66

(52) U.S. Cl. 370/352

(57) ABSTRACT

A multi-mode mobile phone device is equipped to store both PSTN and VoIP phone numbers in a unified, multi-formatted manner. Automatic registration of VoIP new user accounts is conducted using an existing cellular phone number, an existing MAC address, or an existing VoIP identifier, without active participation from the user. Registrations of an existing VoIP account's IP addresses are also conducted without the knowledge of the user of a VoIP device. Unified electronic phonebooks and graphical user interfaces present all phone (PSTN and VoIP) numbers with the same format, with an option to display the mode (PSTN or VoIP) associated with each number. Four-way switching between entire inbound and outbound circuit and VoIP calls is accomplished by intercepting CALL and ANSWER commands issued by the user of a mobile dual-mode phone device. Seamless end-to-send call setup is enabled by using a social network of phone devices using a DHT-based search algorithm on a distributed database.

### FIELD OF THE INVENTION

The present invention relates in general, to multi-mode and single-mode voice services and devices, and more particularly, to seamless setup of VoIP (voice-over-IP) services, seamless switching between VoIP and cellular voice, seamless user experience, and seamless end-to-end voice service.

### BACKGROUND OF THE INVENTION

There is a widespread consensus that, eventually, all traditional voice services will converge to the VoIP platform. The most important voice market in total revenue is that of cellular voice. The devices used for such a service include ordinary cell phones, smart phones, MIDs (mobile Internet devices), PDAs (personal digital assistants), and other handheld devices with cellular voice capability.

While the vast majority of mobile voice devices are tied to cellular voice services, yet there is a growing segment of mobile devices tied to VoIP. Hereafter in this application, all devices (handheld or not) with either a cellular voice or VoIP capacity will be referred to as phone devices or PDs.

Of particular importance is the rapid rise to popularity of dual-mode PDs—for example, Apple's iPhones has taken the market by storm, and Google Phones are expected as a big hit. All these PDs are Wi-Fi enabled; therefore, they can also be used to provide VoIP over Wi-Fi. A Wi-Fi dual-mode PD will hereafter be referred to as a WPD. It is important to recognize that a WPD has two modes: a cellular/circuit mode and a VoIP/packet mode.

Since VoIP services are usually extremely low-priced or free, voice service providers have vigorously resisted the migration to VoIP; and all agree that this migration will take an unpredictably long time. Therefore, demands for dual-mode WPDs will continue for a long time.

The word mode in this application should be interpreted in a liberal sense. In most cases, dual modes will refer to cellular and VoIP modes; other voice-related applications such as video-call-over-IP and PTT (push-to-talk) can be considered as modes as well.

A main purpose of the present invention is to create seamless multi-mode voice in two aspects: user experience and end-to-end service. By seamless user experience it is meant that mode-switching is non-disruptive. By seamless end-to-end service it is meant that there are no infrastructure-based service providers acting as a middleman; voice call setup and tear-down are carried out using social networks of users.

One application enabled by the present invention is automatic switching between cellular voice calls and VoIP calls. Using a seamless WPD, a user will not care nor discern which mode (cellular or VoIP) is being deployed for voice calls.

Another application enabled by the present invention is VoIP between members of ad-hoc group of users. Using the method for automatic VoIP user registration, an ad-hoc group of users can set up their own private phone service without the help of a middleman service provider. It is also possible that, through a method of the present invention, an infrastructure-less service provider offers VoIP and other value-added services with minimal or zero capital and operating expenditures (CapEx and OpEx).

To provide seamless voice experiences, the present invention enables the following features in a WPD: (1) automatic VoIP user registration, (2) seamless call switching, (3) integrated phonebook, and (4) integrated GUIs (graphical user interfaces).

To enable a WPD for VoIP service, it is necessary to carry out two types of registration: device registration, and user registration. A device registration is used for two purposes: (a) to uniquely identify the device within an IP network, and (b) to enable correct routing of data packets between devices. In most cases, device registrations are automatically performed and are totally hidden from the user of a WPD.

In using VoIP, a user is free to use any Internet device for making a call. Unlike cellular voice, a VoIP service provider does not provide communication bandwidths, it provides an infrastructure only to set up, manage, and tear down VoIP calls. Therefore, for a VoIP service, besides device registrations, user registrations are also required.

There are two types of VoIP user registration. First, a VoIP user has to be activated with a provider. This is done on a once-for-all basis, only at service activation. This type of user registration will be referred to as activation registrations.

The second type of user registration arises when a VoIP user attempts to make a call utilizing a VoIP client hosted in an Internet device. To enable correct IP routing of data packets, the IP address of the hosting Internet device must be communicated to the VoIP provider (under which the user has been registered). This type of registrations will be called IP registrations hereafter. An IP registration is needed whenever a VoIP user's device acquires a new IP address; thus, IP registrations are related to user mobility. In markets today, there are no elegant IP mobility technologies; therefore, IP registrations are done in a disconnect-and-reconnect manner. This implies that whenever a WPD moves to a new IP network, and the pre-existing IP address is no longer routable for data packets, VoIP will then cease to function. Only after a new IP address is acquired and a new IP registration is carried out, VoIP on the WPD will be restored.

To provide seamless user experience, it is desirable to enable two features: (1) automatic VoIP activation registrations without active participation of a user; (2) automatic IP registrations, totally hidden from the user. These features make the VoIP user experience as close as possible to the cellular voice experience.

While automatic VoIP activation registration is a nice feature, there are more to offer from a consumer point of view. Today, people have to manage numerous accounts for communications with many different modes (email, online presence, cell phone, VoIP, etc.). Therefore, most users will appreciate any new service without requiring a new ID. In accordance with one aspect of the present invention, a user's VoIP user account ID will be one and the same as an existing cell phone (or PSTN) number. Such a feature will no doubt appeal to a significant segment of consumers.

Since a WPD is a dual-mode device, true seamless user experience will require smooth switching between the two modes. Switching between calls can serve multiple purposes. One purpose is to minimize calling charges; another purpose is to make voice communications feasible. Yet another purpose is to improve the call quality.

There are four possible scenarios for call switching: (a) an outbound cellular call is switched to an actual outbound VoIP call if the outbound callee is available on a VoIP network; (b) an outbound VoIP call is switched to an actual outbound cellular call if the outbound callee is unavailable on all VoIP networks; (c) an inbound cellular call is switched to an actual outbound VoIP call if the inbound caller is available on a VoIP network; (d) an inbound VoIP call is switched to an actual outbound cellular call if the VoIP quality is deemed to be poor.

It is important to recognize that the above four scenarios cover only the case of entire-call switching. Existing FMC (fixed mobile convergence) technologies such as UMA (unlicensed mobile access) and IMS (IP multimedia subsystem) allow an on-going call to freely switch between cellular and VoIP. Such kind of switching requires network infrastructure support and extensive mobility functionalities to be added to a WPD. UMA, IMS, and other compatible technologies support calls that are part-PSTN, and part-VoIP. The present invention, however, focuses on switching between an entire VoIP call and an entire cellular call.

Strictly speaking, a cellular service is carried out over a PLMN (public land mobile network), which is differentiated from a PSTN (public switched telephone network). In this application, however, a PLMN is taken to be a subset of PSTNs.

In a WPD today, two separate phonebooks are being kept: one for the cellular mode, and the other for the VoIP mode. A good reason for keeping two separate phonebooks is that VoIP numbers are usually different in format from regular PSTN numbers. For example, popular Skype VoIP numbers are variable-length alphanumerics, while PSTN numbers follow a strict international standard and are fixed-length numerics.

In addition, a WPD contains a whole host of GUIs. These GUIs allow a user to issue commands and receive messages to and from the device in a graphical manner. In a WPD today, each mode (cellular or VoIP) has its own set of GUIs. Such arrangement makes the user experience disruptive as a user has to move between a PSTN setting and a VoIP setting.

In accordance with one aspect of the present invention, seamless GUIs will provide a unified interface so that all voice commands are not differentiated between the cellular and VoIP modes. However, a user can still find the current mode implicitly by recognizing the phone numbers, or be informed explicitly from the GUI. In a seamless GUI, commands between the two modes are not differentiated, while the GUI still, by option, explicitly displays the mode associated with a phone number.

A technique employed by the present invention is that pre-existing identifiers are used as VoIP identifiers. For example, a pre-existing identifier of a dual-mode PD might be its cellular phone number; a pre-existing identifier of an Internet device might be the MAC (media access control) address of a network interface card (NIC) attached to it. The only condition that is needed for qualifying such a choice is that the pre-existing identifiers are unique within the VoIP user base. Since PSTN phone numbers and MAC addresses are by design globally unique, they naturally qualify for VoIP identifiers.

To provide seamless user experience, human-friendly identifiers are to be linked (using various techniques) to VoIP identifiers. For example, in a PD wherein its MAC address is used as the VoIP identifier, with a linked human-friendly descriptor of the VoIP account, a user does not have to be bothered with the actual VoIP identifier, which is a MAC address. In yet another example, in a WPD wherein its cellular phone number is used as the VoIP identifier, the user will enjoy seamless transitions between his cellular and VoIP calls, as they have the same “phone number.”

To discuss VoIP and PSTN phone numbering systems, it is instructive to mention various standards. For PSTN, E.164 format is mandated by ITU (international telecommunication union) as the international numbering system. For VoIP, a user is identified by a URI (uniform resource identifier). While E.164 format is quite rigid, the URI syntax is very flexible; it is possible to use PSTN numbers and even MAC addresses as URIs.

Yet another aspect of seamless multi-mode voice concerns end-to-end call setup. All voice services today can be said to be infrastructure-based. In one way or another, a service provider with an infrastructure is needed to set up a voice call. For both traditional PSTN/PLMN and VoIP services, a control-plane infrastructure is needed to set up voice calls. It is in this sense that there are no pure end-to-end VoIP services today.

A pure end-to-end VoIP service would mean that only the caller and the callee are needed to set up a call. While this can be done simply by hardwiring (both parties agree to use permanent public IP addresses); the lack of flexibility makes this arrangement extremely impractical. The present invention provides a virtual end-to-end setup solution wherein a group of users forming a social network to register and retrieve IP addresses for VoIP call setup.

This social-networking method is based on the concept of P2P (peer-to-peer). A recent development in P2P technologies is that of P2P-SIP (P2P-session initiation protocol), which is currently being standardized by the IETF (Internet Engineering Task Force). P2P-SIP is actually based on the idea that, in addition to P2P data-plane operations, control-plane operations are to be conducted P2P.

To enable P2P control plane, the IETF P2P-SIP committee has chosen to adopt DHT—(distributed hash table) based search algorithms. In the context of VoIP, the control plane is to store the SIP data in a distributed database, and then a DHT-based search algorithm (such as Chord, Bamboo and Tapestry) is used to locate VoIP call setup information in a P2P manner.

The present invention, however, does not depend on the forthcoming P2P-SIP standards. By embedding DHT-based distributed search algorithms and VoIP databases in PDs and other non-voice and fixed devices, virtual end-to-end VoIP call setup is enabled.

### BRIEF SUMMARY OF THE INVENTION

It is, therefore, an object of the present invention to provide a method to enable automatic VoIP activation registration, without active participation of a VoIP user.

It is another object of the present invention to provide a method to enable automatic VoIP IP registrations, totally hidden from a VoIP user.

It is another object of the present invention to provide a method to seamlessly switch between entire cellular calls and entire VoIP calls.

It is yet another object of the present invention to provide a method to enable integrated phonebooks and GUIs to eliminate the apparent differences between cellular calls and VoIP calls in a multi-mode WPD.

In accordance with one aspect of the present invention, an outbound cellular call is optionally switched to an actual outbound VoIP call if the outbound callee is available on a VoIP network; an outbound VoIP call is optionally switched to an actual outbound cellular call if the outbound callee is unavailable on all VoIP networks; an inbound cellular call is optionally switched to an actual outbound VoIP call if the caller is available on a VoIP network; an inbound VoIP call is optionally switched to an actual outbound cellular call if the VoIP quality is deemed to be poor.

In accordance with one aspect of the present invention, call switching in a WPD is accomplished through a software intercept technique to capture CALL and ANSWER commands from the user of the WPD. To switch an outbound call, the original call is aborted and a new CALL command is issued; to switch an inbound call, the original call is aborted, and an outbound call is initiated to the original inbound caller.

In accordance with one aspect of the present invention, pre-existing identifiers such as PSTN/PLMN phone numbers or MAC addresses are used as VoIP identifiers, as long as they uniquely identify the users in the intended VoIP user base.

In accordance with one aspect of the present invention, all identifiers of the same user and all identifiers of the different modes of the same PD are linked.

In accordance with one aspect of the present invention, while automatic VoIP activation methods are applicable to a WPD, slightly modified methods are applied to any desktop computer, notebook computer, or personal computer.

In accordance with one aspect of the present invention, an integrated phonebook is enabled by a software intercept technique to capture the STORE commands issued to modify phonebook entries.

In accordance with one aspect of the present invention, software intercepts to capture STORE can be replaced by running a background thread that periodically reads the phonebook, and performing the needed translation (from VoIP numbers to E.164 numbers) if needed. This thread can check the phonebook in a periodic fashion.

In accordance with yet another aspect of the present invention, an integrated GUI is enabled by having a VoIP number and a PSTN number appearing in identical formats; these same-format numbers are called unified phone numbers. In such a GUI, there is an option to explicitly display the mode (PSTN or VoIP) associated with a unified phone number.

In accordance with yet another aspect of the present invention, in order to avoid spoofing (faking or theft of a mobile phone number), multiple techniques are deployed: (a) invoking a phone API to retrieve the phone number (MSISDN or mobile subscriber integrated services digital network number); (b) retrieving from the SIM (subscriber identity module) card the IMSI (international mobile subscriber identity), then using the IMSI to query the HLR (home location register) from the provider to obtain the MSISDN; (c) asking the user to enter his phone number.

According to one aspect of the present invention, IP-PBX (private branch exchange) modules are embedded into WPDs or VoIP PDs. Using such an approach, a VoIP infrastructure can be built without any servers; any additional user (either with a multi-mode WPD or a single-mode VoIP PD) will supply an additional unit in control plane resource.

According to yet another aspect of the present invention, a VoIP infrastructure is comprised of boxes and PDs that have embedded software to enable DHT-based search algorithms and IP-PBX functions. A box or PD with such software will be referred to as a grassnode. The set of software modules providing such functionality will be referred to as the grassnode module.

### BRIEF DESCRIPTION OF THE DRAWINGS

The above and other objects and features in accordance with the present invention will become apparent from the following descriptions of embodiments in conjunction with the accompanying drawings, and in which:

FIG. 1 illustrates call switching, between an outbound cellular call and an actual outbound VoIP call, and between an outbound VoIP call and an actual outbound cellular call;

FIG. 2 illustrates call switching, between an inbound cellular call and an actual outbound VoIP call, and between an inbound VoIP call and an actual outbound cellular call;

FIG. 3 depicts a flow chart outlining the logic in call switching based on intercepting the CALL and ANSWER commands;

FIG. 4 depicts a flow chart outlining the logic in converting a VoIP number into a PSTN-format number, based on intercepting the STORE commands issued to modify an electronic phonebook.

FIG. 5 illustrates the working of a grassnode VoIP network wherein fixed grassnodes and grassnode PDs together providing call setup infrastructure for the VoIP service;

FIG. 6 depicts the grassnode software module embedded in a grassnode wherein a SIP server module and an IP-PBX module are the main components.

### DETAILED DESCRIPTION OF EXEMPLARY EMBODIMENTS

A foundation of the present invention is the management of user identification in a convergent voice communications system—PSTN phone numbers and VoIP phone numbers. PSTN numbers are to comply with the E.164 numbering system or a compatible system, while a VoIP user is identified by a URI.

Hereafter, any VoIP service that is set up using a network of grassnodes (boxes or PDs embedded with a grassnode module) will be referred to as a grassnode VoIP service. It is important to recognize that a grassnode VoIP service can be totally ad-hoc (no service providers are involved as the service is conducted as a private-club function), or a VoIP service with a virtual network operator.

The present invention incorporates two steps to circumvent the differences in user identifiers: (a) allowing a pre-existing identifier to be used as a VoIP identifier; (b) linking all identifiers associated with the same user or same device. The only qualification on allowable pre-existing identifiers is that these numbers must uniquely identify users in the intended VoIP user base. Obviously, official PSTN numbers and MAC addresses are uniquely assigned; they automatically satisfy the unique identification qualification.

A pre-existing identifier can be: (a) a PSTN phone number; (b) a PLMN phone number; (c) a MAC address; (d) a VoIP identifier. Since the URI syntax is very flexible, it is possible (even without modification) to convert all kinds of pre-existing identifier to an URI-format VoIP identifier.

To link identifiers, two factors are to be considered: (a) all identifiers of the same user accounts must be linked; (b) identifiers of different modes of the same PD (VoIP and PSTN, for example) are to be linked. In particular, among different identifiers of a user to be linked, a natural-language description should be included.

According to one embodiment of the present invention, a grassnode PD is equipped to execute its VoIP activation registration by automatic registration software. This software can be downloaded from a Web site, pre-installed by factory, or inserted by other communication means into the PD. This software module will be called grassnode ID-RT (ID retrieve). Grassnode ID-RT will retrieve either a cell phone number (in case the PD is a cell phone device) or a MAC address (in case the PD is an Internet device).

In the case of cell phone, grassnode ID-RT will deploy three possible approaches to retrieve the cell phone number: (a) invoking a phone API (application program interface) to retrieve the MSISDN; (b) retrieving from the SIM card the IMSI, then using the IMSI to query the HLR from the current provider to obtain the MSISDN; (c) asking the user to enter his phone number.

Sub-case (c) is designed specifically to prevent spoofing. After receiving the cell phone number from the user, this number is sent by grassnode ID-RT to a security server; the security server will then send a SMS (short message service) text message with a password. This password will allow the user to continue the activation registration.

In the case of an Internet device, grassnode ID-RT will automatically search for the MAC address associated with the device and will use the found MAC address as the VoIP user identifier, without any inputs from a user.

According to yet another embodiment, the grassnode ID-RT will perform seamless ID switching as soon as the identifier used in that node is removed. Two examples are identifiers based on the cellular phone number and the MAC address. The first example occurs when a user removes the SIM card from his or her cell phone and exchanges it for a new one. The second example occurs when a user removes the network interface card (NIC) from his or her laptop and replaces it for a new one with a new MAC address. In any of these scenarios, the ID-RT module performs the following actions. Upon detecting that the identifier resource (e.g. SIM card or NIC card) is removed, it unregisters that identifier from the system. Upon detecting that a new identifier resource is added (e.g. a new SIM card is inserted in the phone or a new NIC card is attached to a laptop), it searches for the new identifier in this resource and proceeds to register it.

According to yet another embodiment of the present invention, the automatic registration software will allow a user to enter his personal information as an option in the registration process.

In accordance with one aspect of the present invention, switching between entire cellular calls and entire VoIP calls in a WPD is accomplished through a software intercept technique. To switch an outbound call, the original call is aborted and a new CALL command is issued; to switch an inbound call, the original call is aborted, and a new outbound call is initiated to the original caller. As switching an inbound call represents a refusal to accept a call, such actions may convey the idea of impoliteness; inbound call switching is best provided as an option.

If the caller in the inbound call uses a grassnode MPD, then the two grassnode MPDs can collaborate to create a seamless call switching. In this case, the inbound caller does not see a call rejected; the reject signal is specialized such that it tells the grassnode software on the caller side that there will be an immediate inbound call. Therefore, the grassnode module hides the first reject from the caller and waits for the second call; when the second call is successful, then it returns OKAY (part of SIP signaling for VoIP) to the original callee (now the caller).

On the other hand, switching outbound calls can be set to be automatic or optional. One way to embody optional switching is to allow the user of a WPD to accept or reject a switching decision proposed through a GUI.

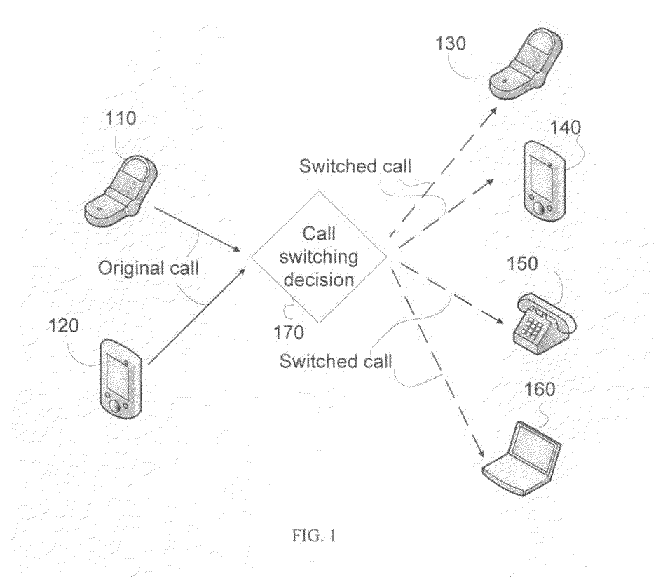

FIG. 1 depicts the decision and event flow for switching outbound calls. Here the WPD is represented logically by two separate modules: cell phone module 110 and VoIP module 120. A CALL command issued by the user is intercepted by the call switching decision module 170. If the outbound call is a cellular call to a callee with a cell phone 130 or a desk phone 150, and if the same callee is found to be available also through a VoIP device 140, or a laptop 160, then the call can be switched. Here the VoIP device 140 and the cell phone 130 can be hosted in the same physical device; thus the physical device is actually a dual-mode phone.

The call decision module 170, upon learning the availability of the same outbound callee on either the device 140 or 160, will abort the original call and set up a new VoIP call, directly from the VoIP module 120 to either module 140 or 160, depending on availability of the same callee on module 140 or 160, based on IP registration.

FIG. 1 also depicts the case for a VoIP call switching to a cellular call. In this case, the condition for switching could be that the outbound callee is unavailable in all VoIP networks. The same human callee might have multiple VoIP accounts, or one VoIP account with two different online IP addresses. If the callee is unavailable in all VoIP networks known, then it is desirable to switch the VoIP call to a cellular call to cell phone device 130 or desk phone device 150. Another condition to switch is that the quality of current VoIP calls is deemed to be poor. This can be determined by using a threshold on the Wi-Fi signal strength received at the WPD.

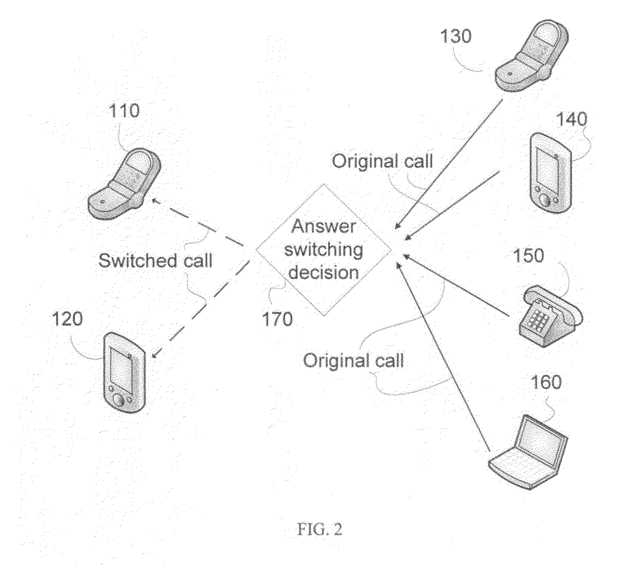

FIG. 2 depicts the decision and event flow for switching inbound calls. Again, the modules 10 and 120 represent logical modules inside the same WPD. Here a caller could be calling from a PLMN line (through device 130), or from a PSTN line (through desk phone 150). The same caller could also be calling from a VoIP device 140 or a VoIP client in a laptop 160.

A reason to switch an inbound cellular call might be to save air-time charges for the receiving cell phone module 110 and/or the caller PLMN 130 or PSTN 150 lines. If indeed the same caller is found to be available on VoIP device 140 or 160, then the inbound cellular call could be refused, and a new outbound call could be initiated from the VoIP module 120 to the original caller (now becoming a callee) through device 140 or 160.

The event flow for FIG. 2 is that the call switching decision module intercepts the ANSWER command, and then optionally asks the user of the WPD to accept a call switching or automatically conducts the switching, depending on the options selected. Note that it is important to intercept the ANSWER commands to determine inbound call switching. The reason is that the user of the WPD may decide not to answer an inbound call, and the call switching software should do nothing in this case.

FIG. 2 also depicts the situation for switching an inbound VoIP call. A possible reason to switch such a call is that the decision module 170 deems the quality of the current VoIP channel to be too poor. This again can be determined with the help of a threshold on the Wi-Fi signal strength received at the WMPD, for example.

As is with the case scenario presented in FIG. 1, the VoIP device 140 and the cell phone 130 in FIG. 2 can be hosted in the same physical device; thus making the physical device a dual-mode phone.

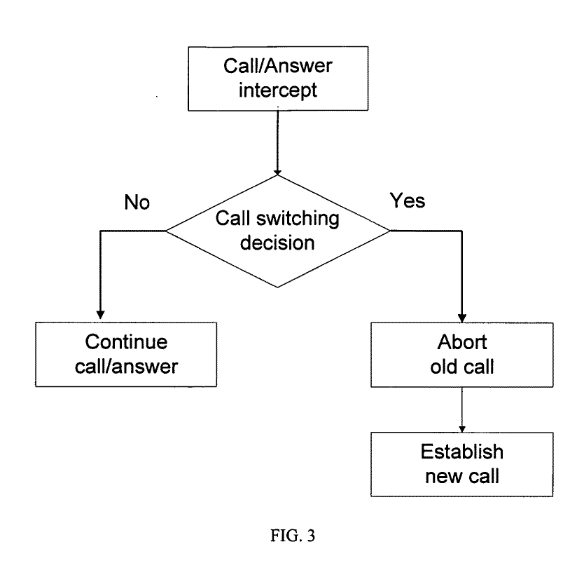

FIG. 3 provides a basic flow chart for call switching. Here a software intercept technique is deployed to intercept both the CALL and ANSWER commands issued by the user of a WPD. To switch, the original call will be aborted, and a new call will be subsequently established.

According to an embodiment of the present invention, a unified identifier system is created to eliminate format differences between a VoIP phone number and a PSTN phone number. In this unified identifier system, a phone number is stored in multiple formats, and one of which is a natural-language description of a contact or a device, entered by a user of a WPD. Further, each VoIP user identifier is linked to an E.164 phone number.

In yet another embodiment, the method of automatic VoIP activation registration is implemented in VoIP client software to be used in a desktop or laptop computer. In this embodiment, a user is given an option to enter his preferred VoIP identifier, while the default is an identifier in the E.164 format.

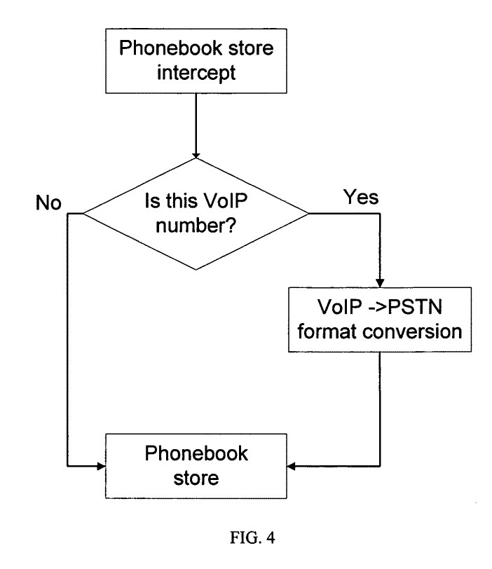

According to an embodiment of the present invention, a single integrated phonebook is maintained in a WPD. In this embodiment, a software intercept technique is used to capture the STORE commands issued to modify the phonebook entries. This process is illustrated as a flow chart in FIG. 4: if the STORE command is associated with storing a non-E.164 formatted VoIP phone number, that phone number is converted into an E.164 PSTN number. Therefore, in the single integrated phonebook, all phone number entries are E.164-formatted numbers.

To map a VoIP URI into an E.164 number, a function f_e(.) is used. The only restrictions on f_e(.) are: (1) it is an 1-to-1 mapping; (2) the range space must be the set of international phone numbers, at the maximum length of 15 digits; (3) the prefix must correspond to a country code which is not assigned to any real country or area. For example, a VoIP number given by SIP:username@hostname is converted into 422-89-1234-56789.

According to another embodiment of the present invention, integrated GUIs are used to interact with the user of a WPD. In these GUIs, unified VoIP numbers and PSTN numbers all appear in identical formats. In such a GUI, there is an option to explicitly display the mode (PSTN or VoIP) associated with a unified phone number.

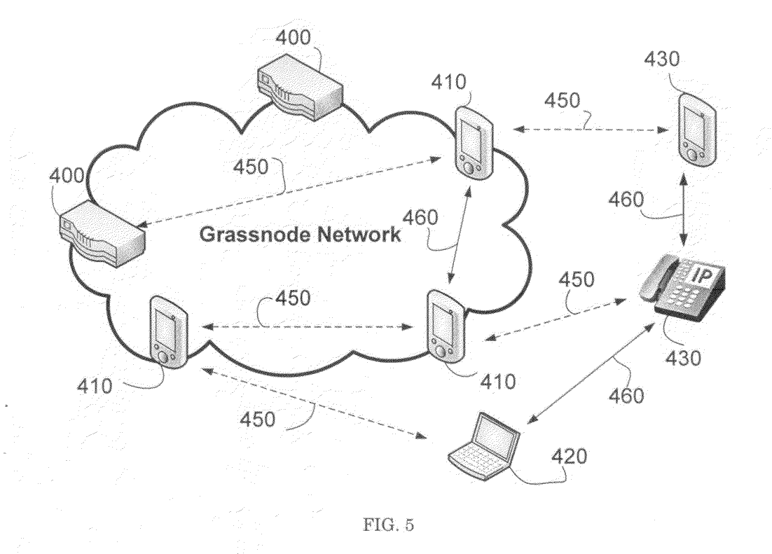

FIG. 5 illustrates the working of a grassnode network providing VoIP call setup (or signaling). In the figure, grassnodes 400 represent fixed grassnode boxes that are connected to the Internet, and PDs 410 represent grassnode mobile phone devices (MIDs, smart phones, VoIP phones, laptops, etc.) that are connected to the Internet. Signaling (control plane) communications are represented by the arrows 450, and VoIP data plane communications are represented by the arrows 460. Other VoIP devices are represented by 430 (a non-grassnode VoIP device), 460 (a non-grassnode VoIP fixed phone), and 420 (a non-grassnode laptop computer with VoIP client software).

In a typical operation, a non-grassnode VoIP device will query a grassnode device (mobile or fixed) to set up a VoIP call. Each grassnode hosts a partial VoIP database, which in most cases, is a distributed SIP database, wherein (VoIP identifier, IP address) pairs are stored, along with other information needed in a SIP-based VoIP database.

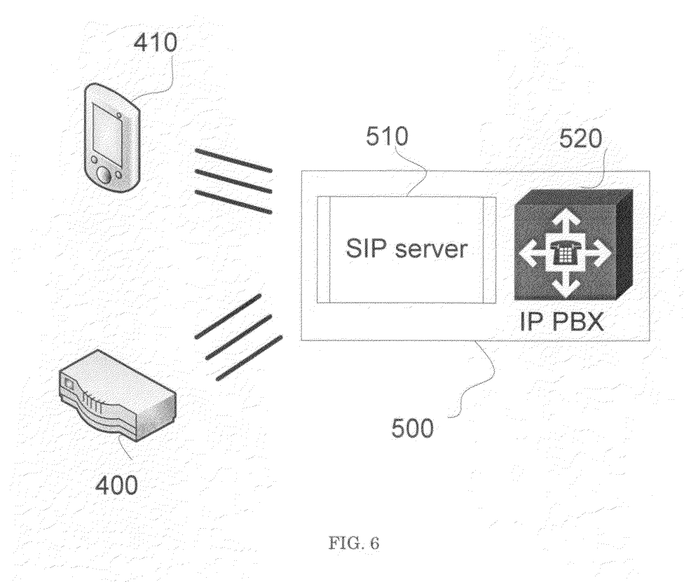

Each grassnode module embedded in a grassnode is comprised of two main components: SIP server and IP-PBX, as illustrated in FIG. 6. Together, the SIP server and IP-PBX perform the functions of a proxy server, a registrar server, a redirect server, a location server, or any combination thereof, for a SIP-based VoIP system. The main difference between an ordinary SIP-based VoIP system and a grassnode VoIP system is that the SIP database is stored in partial databases distributed across a plurality of grassnodes. To locate needed information for call setup, a DHT-based search algorithm is used. Such communications are called signaling and are represented by the arrows 450 in FIG. 5.

What is claimed is:

1. A method of unified PSTN-VoIP phone numbering system to create seamless user experience in a voice device, comprising:
VoIP phone numbers registered in URI formats;
PSTN phone numbers stored in E.164 or compatible formats;
unified phone numbers stored in pre-determined formats;
other identifiers for PSTN or VoIP users stored in a plurality of formats;
wherein a said unified phone number is associated with either a said VoIP phone number or a said PSTN phone number; all said identifiers associated with a said user are linked; and all said identifiers associated with a same said voice device are linked.

2. The method of claim 1, wherein a said voice device is an item of the list, while not being restricted to: a cell phone, a smart phone, a personal digital assistant, a mobile Internet device, a laptop computer, a desktop computer, or any device that is capable of servicing circuit-switched voice calls, or VoIP calls, or both.

3. The method of claim 2, wherein an automated VoIP user registration system is built using the unified numbering system, further comprising:
registering a new VoIP user;
registering for an existing VoIP user with an updated or additional IP addresses;
wherein human user participation is not required in all said registrations.

4. The method of claim 3, wherein a said new VoIP user identifier is set to be one of the following: an existing PSTN number of a circuit voice service, an existing MAC address of a said phone device, an existing VoIP user identifier, or a user-entered VoIP identifier.

5. The method of claim 2, wherein a unified phonebook is used to maintain a contact list in a mobile phone device, further comprising:
a plurality of STORE commands to modify said phonebook is intercepted or read;
if a said STORE command is to store a non-PSTN number, said non-PSTN number is converted into a PSTN format.

6. The method of claim 2, wherein unified GUIs are used to perform interactions between a said phone device and a user of said device, further comprising:
all said phone numbers in a said GUI are of the same format;
with an option, a said phone number is displayed with its mode, which has at least two choices: PSTN or VoIP.

7. The method of claim 4, wherein in conducting VoIP activation registration, a user of a said multi-mode phone device is asked to enter his PSTN phone number; an SMS text message is further sent to the user using said phone number containing a password to allow continued said activation registration.

8. The method of claim 5, wherein a new VoIP registration is initiated whenever a said phone device is modified to be associated with a new PSTN phone number.

9. A computer-readable medium with a computer program for performing the method as described in any one of claims 1 to 8.

10. A method to switch between entire circuit calls and entire VoIP calls in a multi-mode phone device, comprising:
a switch decision module to intercept CALL and ANSWER commands issued from a human user of said phone device;
a four-way switching matrix: an outbound circuit call switching to an outbound VoIP call, an outbound VoIP call switching to an outbound circuit call, an inbound circuit call switching to an outbound VoIP call, and an inbound VoIP call switching to an outbound circuit call;
wherein switching from a said call to another said call implies the first said call is terminated while second said call is subsequently initiated; and a said phone device is referred to as grassnode phone device.

11. The method of claim 10, wherein a said multi-mode phone device is an item of the list, while not being restricted to: a cell phone, a smart phone, a personal digital assistant, a mobile Internet device, a laptop computer, a desktop computer, or any device that is capable of servicing both circuit voice calls and VoIP calls.

12. The method of claim 11, wherein the switching logic in the decision tree is further comprised of:
if an outbound callee on a circuit call is also available on a VoIP channel, then said outbound circuit call is switched to an outbound VoIP call;
if an outbound callee on a VoIP call is unavailable on all available VoIP channels, then said outbound VoIP call is switched to an outbound circuit call;
if an inbound caller on a circuit call is also available on a VoIP channel, then said inbound circuit call is switched to an outbound VoIP call;
if an inbound a VoIP call is determined to be of poor quality and said inbound caller has a PSTN phone number, then said inbound VoIP call is switched to an outbound circuit call.

13. The method of claim 12, wherein said switching logic in the decision tree when both said caller and callee are both using a said grassnode phone device is further comprised of:
if an inbound caller on a circuit call is also available on a VoIP channel, then said inbound circuit call is rejected by special signaling to the caller, wherein said caller GUIs do not show said call being rejected;
if an inbound caller on a VoIP call is determined to be of poor quality and said inbound caller PD has a PSTN phone number, then said inbound VoIP call is rejected by special signaling to the caller, wherein said caller GUIs do not show said call being rejected.

14. A computer-readable medium with a computer program for performing the method as described in any one of claims 10 to 13.
